(19) United States
(12) Patent Application Publication
(10) Pub. No.: US 2011/0215485 A1
(43) Pub. Date: Sep. 8, 2011

(54) Home carbonator designed to work with used consumer product bottles; especially used drink bottles

(76) Inventor: Benjamin H. Steinberg, Pendleton, IN (US)

(21) Appl. No.: 12/660,918

(22) Filed: Mar. 8, 2010

(51) Int. Cl. B01F 3/04; B65D 83/00

(52) U.S. Cl. 261/64.1; 261/64.4; 222/78; 261/DIG. 7

(57) ABSTRACT

Home carbonator designed to work with used consumer product bottles; especially used drink bottles. This device should work with any or all type(s) of product bottle, and can utilize any type of pressurized CO₂ container which is sufficient to achieve the carbonation process (High enough pressure)

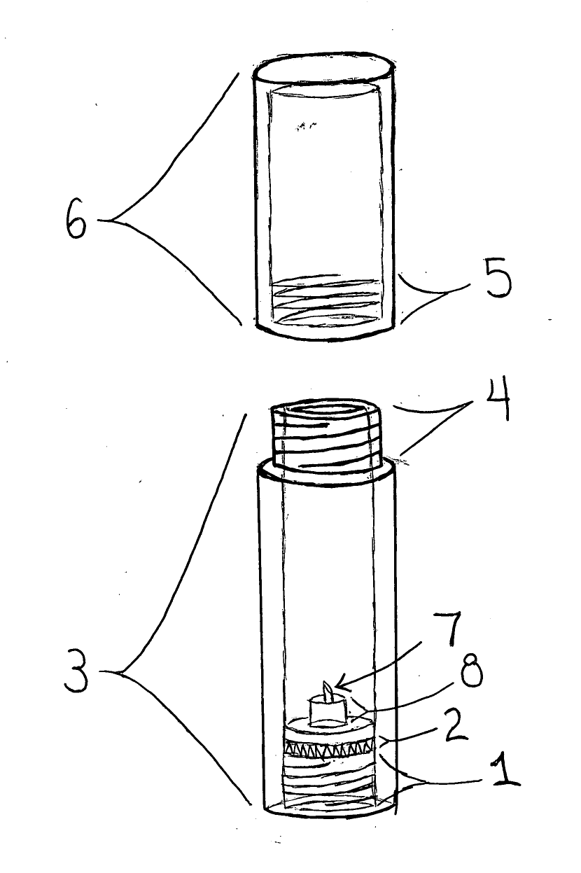

### CROSS REFERENCE TO RELATED APPLICATIONS

N/A

### STATEMENT OF ANY FEDERALLY SPONSORED RESEARCH AND DEVELOPMENT

N/A

### SEQUENCE LISTING

N/A

### BACKGROUND OF THE INVENTION

Drink carbonation systems designed for home use have been made commercially available in the past. They have to date, however, only been made available so as to work with the drink/liquid container which came as an included part of said system. As this previously necessary inclusion incurs cost, and as consumers usually have perfectly usable bottles and containers lying around the house (including post-use consumer product containers of all types, and especially 2-liter type drink bottles), the novel concept described herein is of a simple home carbonation kit/unit which is sold alone (with no liquid container) and which is designed to snap, clamp, screw on or otherwise securely attach to a used consumer product bottle (such as a used 2-liter bottle) sufficiently so that the user may carbonate the liquid held in the container.

### BRIEF SUMMARY OF INVENTION

I first envisioned a small plastic unit, 2 pieces which screw together and back apart; cylindrical when screwed together, about 4-5″ tall and 1¼ to 1¼″ in diameter and able to hold a foodservice Carbon Dioxide charger inside. The device should be screwed apart into two shorter cylinders and the bottom cylinder/plastic piece should be screwed securely onto the top of a 2-liter bottle which the user has filled with a drink he/she wishes to carbonate (such as Kool-Aid, lemonade, fruit juice, etc). The user should drop a CO₂ charger into the cylinder atop the 2-liter, screw the top plastic piece of my invention onto the piece which is already secured to the top of the 2-liter (which has the CO₂ charger inside) and the action of the two plastic pieces being screwed together should press the tip of the CO₂ charger onto a pin inside my invention. The pressure should pierce the tip of the charger on the pin, releasing the CO₂ into the drink, creating pressure in the 2-liter bottle, and carbonating the drink.

### BRIEF DESCRIPTION OF SEVERAL VIEWS OF THE DRAWING

1. Threads on bottom plastic piece allow it to be secured to a container tightly.

2. Rubber gasket at inside of (1) makes airtight seal so that CO₂ does not leak from device connection to container

3. Lower half plastic cylinder

4. Threads on lower half plastic cylinder allows for it to be secured to the upper half, and by twisting when being used, to press CO₂ charger tip onto (7) piercing it.

5. Threads on upper half plastic cylinder allows for it to be secured to the lower half, and by twisting when being used, to press CO₂ charger tip onto (7) piercing it.

6. Upper half plastic cylinder

7. Metal charger tip piercer

8. Rubber gasket at piercing tip makes airtight seal so that CO₂ does not leak from charger tip connection to inside of device.

### DETAILED DESCRIPTION OF THE INVENTION

On thorough review of the invention described in the “Summary of the Invention” section (VI), I've decided this more thorough description seems to more appropriately encompass the whole scope of the unique concept described herein. The home carbonator system is unique in that it works with an outside container that the user may find lying around their home. This means that this invention should be able to be attached to any post-consumer use product bottle. A single device could be designed to work with any particular type of product bottle (So that it could be attached to a 2-Liter bottle OR it could be attached to a Gallon Milk jug OR . . . etc.)), or to work with a few (So that it could be attached to a 2-Liter bottle AND it could be attached to a Gallon Milk jug AND . . . etc.) It should be able to attach to the drink container by any sufficient method (Screw on, clamp on, snap on, etc.) It should also be able to utilize any type of pressurized CO₂ container which is sufficient to carbonate liquid (Foodservice CO₂ Charger or Other CO₂ holding container such as a gas cylinder). This device allows for the user to carbonate their own beverages at home by simply placing a liquid into a container they might find lying around their house such as a empty 2-Liter bottle, attaching and utilizing the device.

1. Home carbonator system which can be snapped, clamped, screwed, or otherwise sufficiently attached to a consumer product bottle (presumably post-use) such as a 2-liter bottle, milk jug, shampoo bottle, etc., and which then can proceed to carbonate liquid in said container.

2. Device of claim 1 which is shaped in any of various manners including, but not limited to: Superhero action figurines, cartoon figurines, common shapes, etc.

3. Device of claim 1 on which is printed any of various designs including but not limited to: Patterns, superheroes, movie characters, cartoon figurines, pictures, etc.
